(19) United States
(12) Patent Application Publication
(10) Pub. No.: US 2026/0108993 A1
(43) Pub. Date: Apr. 23, 2026

(54) HOUSING PART FOR A CLAMPING AND/OR BRAKING DEVICE

(71) Applicant: HEMA MASCHINEN- UND APPARATESCHUTZ GMBH, Seligenstadt (DE)

(72) Inventor: Edmund Likus, Seligenstadt (DE)

(21) Appl. No.: 19/121,298

(22) PCT Filed: Jul. 16, 2024
(86) PCT No.: PCT/EP2024/070101

§ 371 Date: Apr. 15, 2025

(30) Foreign Application Priority Data
Aug. 24, 2023 (DE) 10 2023 122 783.1
Aug. 24, 2023 (DE) 20 2023 104 835.8

(51) Int. Cl. B23Q 1/00

(52) U.S. Cl. CPC B23Q 1/0009

(57) ABSTRACT

The invention relates to a housing part for a clamping and/or braking device and to a clamping and/or braking device having such a housing part. The housing part comprises: a first edge of the housing part and a second edge of the housing part opposite the first edge; an annular recess arranged between the second edge and the first edge for clamping an annular spring plate between a first bearing surface of the housing part defined by the recess and a second bearing surface of the housing part defined by the recess; a clamping element having a clamping surface which is designed, when the spring plate is clamped in the recess between the first bearing surface and the second bearing surface in such a way that a first end of the spring plate is supported on the first bearing surface and a second end of the spring plate presses onto the second bearing surface, to transmit a clamping and/or braking force to an object to be clamped and/or braked; a first housing contact surface which extends between the first edge and the first bearing surface; wherein at least one groove for receiving a sealing means is arranged on the first housing contact surface.

### TECHNICAL FIELD

The disclosure relates to a housing part for a clamping and/or braking device and to a clamping and/or braking device having such a housing part.

### BACKGROUND

In the production of tool or machine parts, machining machines, in particular work spindles or other machine tools, are used which machine material from a workpiece by means of tools fastened to a shaft, in particular in order to bring it into the desired shape. The shaft can be an axis of rotation or pivot axis of such a machine. Furthermore, tables which rotate or pivot by means of a shaft are used to place tools or workpieces into the suitable machining position or to move workpieces at corresponding rotational speeds. A prerequisite for precise and efficient machining is, inter alia, a high rotational speed of the shaft. Emergency or safety systems therefore have the task of stopping the shaft in the event of a fault or failure of the systems, such as, for example, a power failure or cable breakage, or of holding it in a fixed position and thus fixing it.

Common machining machines have electromagnetic, hydraulic or pneumatic clamping and/or braking devices. Such devices have a friction lining which can be frictionally connected to the shaft by means of force transmission. This enables the shaft to be fixed at different speeds.

In hydraulic clamping devices, a chamber is acted upon by hydraulic oil and clamps the rotating shaft or disk firmly. Passive hydraulic clamps are also known. However, such hydraulic clamps have long reaction times or short reaction times require a very high outlay there. Furthermore, the hydraulic material, in particular hydraulic valves and hydraulic pipes, is costly and requires longer assembly times. The hydraulic oil also results in an additional outlay for maintaining cleanliness in the surroundings of a hydraulic clamp.

In pneumatic clamping and/or braking devices, elastic elements, in particular resilient plates, are usually acted upon by compressed air and can overcome some of the aforementioned disadvantages of hydraulic clamping devices.

EP 1 585 616 B1 and EP 1 651 881 B1 describe pneumatic clamping devices with two annular spring plates, which are introduced into a housing of the clamping devices and form a pressure space there, which can be acted upon by compressed air or aerated and dearated in order to change the bending of the spring plates and as a result to change between a closed state of the clamping devices, in which an object to be clamped, such as a rotatable shaft, is clamped, and an open state of the clamping devices, in which the object is free. In practice, however, it has been shown that the housing parts of the clamp do not seal sufficiently with respect to one another and to the surroundings and fail or cannot be operated without faults.

### SUMMARY

Proceeding from the prior art mentioned at the outset, the disclosure is based on the object of providing means which enable a pneumatic clamping and/or braking device to provide better sealing.

The object is achieved with a housing part having the features of patent claim 1 and with a clamping and/or braking device having the features of patent claim 17 or 18. Preferred embodiments are described in the dependent claims, in the description and in the figures.

According to the solution according to the invention, a housing part for a pneumatic clamping and/or braking device is provided, the housing part comprising: a first edge of the housing part and a second edge of the housing part opposite the first edge; an annular recess arranged between the second edge and the first edge for clamping an annular spring plate between a first bearing surface of the housing part defined by the recess and a second bearing surface of the housing part defined by the recess; a clamping element having a clamping surface which is designed, when the spring plate is clamped in the recess between the first bearing surface and the second bearing surface in such a way that a first end of the spring plate is supported on the first bearing surface and a second end of the spring plate presses onto the second bearing surface, to transmit a clamping and/or braking force to an object to be clamped and/or braked; a first housing contact surface which extends between the first edge and the first bearing surface; wherein at least one groove for receiving a sealing means is arranged on the first housing contact surface.

Preferably, the distance of the second bearing surface from the second edge or the clamping surface is smaller than the distance of the first bearing surface from the second edge or the clamping surface. The second edge can be the edge of the housing part, on or at which the clamping surface is provided or which, in the state installed in the clamping and/or braking device, is closer to the object to be clamped or braked and possibly touches this object in the closed state.

Preferably, the distance of the first bearing surface from the first edge is smaller than the distance of the second bearing surface from the first edge. The first edge can be the edge of the housing which, in the state installed in the clamping and/or braking device, faces away from the object to be clamped or braked or is further away from the object than the second edge. Holes for fastening the housing part to another housing part for forming the clamping and/or braking device can be arranged along the first edge.

According to the solution according to the invention, a clamping and/or braking device for clamping and/or braking an object to be clamped and/or braked is furthermore provided, the device comprising: a housing comprising a first housing part according to the invention and a second housing part according to the invention, wherein the two housing parts are arranged with respect to one another and fastened to one another in such a way that the first housing contact surface of the first housing part faces the first housing contact surface of the second housing part, and that the recesses of the first and second housing parts together form an interior space within the housing; a spring which is arranged in the interior space and comprises a first annular spring plate and a second annular spring plate, wherein the spring plates are arranged within the interior space in such a way that at least one pressure space is formed in the interior space, which pressure space is at least partially delimited by the spring plates, wherein the pressure space can be aerated or deaerated and can be subjected to overpressure of a pressure medium which is suppliable to the housing, wherein the first spring plate is clamped between the first bearing surface of the first housing part and the second bearing surface of the first housing part; wherein the second spring plate is clamped between the first bearing surface of the second housing part and the second bearing surface of the second housing part; and wherein the spring plates are arranged relative to the at least one pressure space in such a way that, by aerating or deaerating the pressure space or subjecting the pressure space to overpressure, a bending of at least one of the spring plates can be changed and as a result the device changes between an open state, in which the object is spaced apart from the clamping surfaces, and a closed state, in which one or more of the clamping surfaces transmit a clamping and/or braking force to the object. A sealing means can be received in each of the housing parts in the respective groove. In this case, a respective separate sealing means (that is to say a total of at least two sealing means per housing of the clamping and/or braking device) can be present in each of the housing parts or a single sealing means can be received in the grooves of the housing parts when the housing parts are fastened to one another.

The problem of the fault-prone operation of the clamping and/or braking devices owing to leakage between the housing parts and with respect to the surroundings could be overcome by aspects of this disclosure. The following findings of the inventors are based on the disclosure. In the past, large amounts of sealing compound were applied areally between the housing parts of a clamp in order to produce a seal between the housing parts and with respect to the surroundings. However, a sealing compound applied areally is prone to fault, for example because it is not applied uniformly wherever it is required or where it is not applied. The inventors have found that the insertion of a groove on the first housing contact surface, which groove serves for contacting the housing part with another housing part and extends between the first edge and the first bearing surface of the housing part, leads to less fault-prone clamping and/or braking devices for the targeted introduction of a sealing means, such as a sealing compound (e.g. adhesive and sealing material) or an elastic material (e.g. O-ring), since the location of the sealing means which can be received by the groove is defined by the groove, the sealing means can be attached more reliably and a reliable seal between the housing parts and with respect to the surroundings is thus achieved. In particular, an improved seal of the pressure space which is located between each spring plate and the associated housing part and which is prone to leakage is achieved by the groove. Overall, the groove on the first housing contact surface reduces the susceptibility to fault and increases the operating time of a clamp. It has also been possible in this way to reduce the amount of required sealing means (such as sealing compound, e.g. adhesive and sealing material) which has been required hitherto for the reliable seal, which reduces costs and is environmentally friendly. In this case, the attachment of the groove to the first housing contact surface has no negative effect on the dynamics of the opening and closing of the clamping and/or braking device.

According to preferred aspects of the disclosure, the groove has a width of 1 mm to 2 mm, 1.4 mm to 1.6 mm, or approximately 1.5 mm. Alternatively or additionally, the groove has a depth of 0.5 mm to 1.0 mm, 0.65 mm to 0.75 mm, or approximately 0.7 mm. In a given section of the groove, the preferred extent or the preferred volume of the sealing means to be received is thereby defined and the probability that too little or too much sealing means is applied is thus reduced.

According to a preferred aspect of the disclosure, the cross section of the groove can be in the form of a V (V-shaped), a rectangle open on one side, a U (U-shaped) or a semicircle. These shapes are particularly preferred for the reception and reliable mounting of the sealing means. Other shapes of the groove are possible.

According to preferred aspects of the disclosure, the at least one groove runs at least partially around the centre point of the annular recess or extends at least partially along an arc of a circle, wherein the arc of a circle preferably spans a centre angle of at least 45°, 90°, 120°, 135°, 160°, 180°, 225°, 270°, 315°, 350°, or 360°. The groove can be of approximately circular or annular configuration. The groove runs at least partially around the first edge. As a result, the groove promotes a seal which is as uniform as possible or even symmetrical at least in sections of the first edge, which is conducive to a longer operation of the clamp.

According to preferred aspects of the disclosure, the first housing contact surface furthermore has one or more holes for fastening the housing part to another housing part by means of a fastening means, and the at least one groove extends on the first housing contact surface between the holes and the first bearing surface, wherein the holes are arranged on the first housing contact surface between the first edge and the at least one groove. In other words, the holes are located outside the groove as viewed from the object to be clamped or braked, with the result that the holes and the fastening means to be attached therein cannot negatively influence the seal between the housing parts and with respect to the surroundings. This additionally increases the seal and reduces the susceptibility to fault.

According to preferred aspects of the disclosure, the housing part has one, two or more ports for applying a pressure medium (for example compressed air) to the housing part (in particular the one or more pressure spaces). In this case, the at least one groove is preferably interrupted by one or more of the ports, with the result that a gap for the port follows a section of the groove and another section of the groove which continues after the interruption by the port then follows again. Alternatively or additionally, the at least one groove on the first housing contact surface runs between the first edge of the housing part and one or more (other) ports and preferably runs at least partially around the ports. This additionally increases the seal since the groove is guided as far as the ports and possibly even runs partially around the ports in such a way that the sealing means located in the groove seals the ports with respect to the first edge of the housing part and therefore with respect to the surroundings. This reduces the susceptibility to fault by reducing leakage in the region of the ports.

By means of the means described here individually and in combination, it is possible to provide clamps which seal reliably between the housing parts and with respect to the surroundings without the dynamics of the opening and closing of the clamp being adversely affected as a result.

If this brief description describes features which are not listed in the patent claims, these features do not constitute essential features and do not necessarily have to be included in the patent claims, but these features are particularly prominent preferred realizations of the claimed subject matter, can be combined with each of the patent claims and can also be combined with one another as desired.

### BRIEF DESCRIPTION OF THE FIGURES

FIG. 1A shows a schematic cross section through an inwardly directed, passive pneumatic clamping and/or braking device according to the invention in the closed state.

FIG. 1B shows a schematic cross section through an outwardly directed, passive pneumatic clamping and/or braking device according to the invention in the closed state.

FIG. 2A shows a schematic cross section through an inwardly directed, passive pneumatic clamping and/or braking device according to the invention in the open state.

FIG. 2B shows a schematic cross section through an outwardly directed, passive pneumatic clamping and/or braking device according to the invention in the open state.

FIG. 3A shows a schematic cross section through an inwardly directed, active pneumatic clamping and/or braking device according to the invention in the open state.

FIG. 3B shows a schematic cross section through an outwardly directed, active pneumatic clamping and/or braking device according to the invention in the open state.

FIG. 4A shows a schematic cross section through an inwardly directed, active pneumatic clamping and/or braking device according to the invention in the closed state.

FIG. 4B shows a schematic cross section through an outwardly directed, active pneumatic clamping and/or braking device according to the invention in the closed state.

FIG. 5A shows a cross section through a pneumatic clamping and/or braking device according to the invention in a three-dimensional representation.

FIGS. 5B to 5D show a variant of a housing part taken from FIG. 5A.

FIG. 6 shows a section through a variant of a housing part according to the invention.

FIG. 7 shows a plan view of an annular spring plate.

FIG. 8 shows a plan view of a variant of a housing part according to the invention for use with the annular spring plate according to FIG. 7.

Components which are represented in a plurality of figures bear the same reference symbols.

### DETAILED DESCRIPTION

The disclosure relates to a housing part for a clamping and/or braking device and to a clamping and/or braking device having one or more such housing parts.

If the device “clamp” or “clamping device”, the “clamping force” or the process of “clamping” is referred to in this document, then the device of the “brake” or “braking device” or the “braking force”or the process of “braking”is likewise also encompassed.

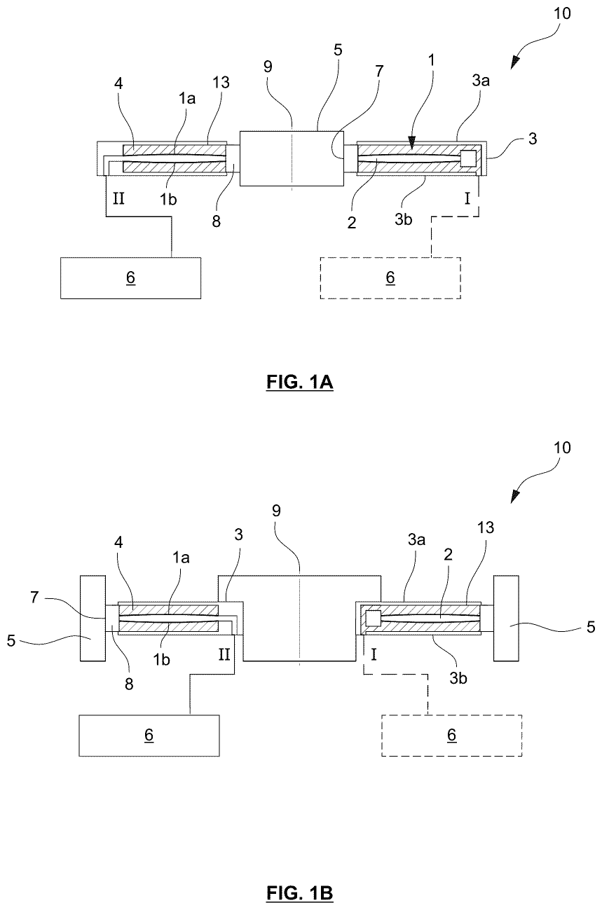

FIGS. 1A to 5A schematically show cross sections through such a clamping device 10 according to the invention having a housing 3 which comprises two housing parts 3a, 3b according to the invention, and having a spring 1 which is arranged in the housing 3 and comprises at least two elastic elements 1a, 1b, in each case in the form of an annular spring plate 1a, 1b.

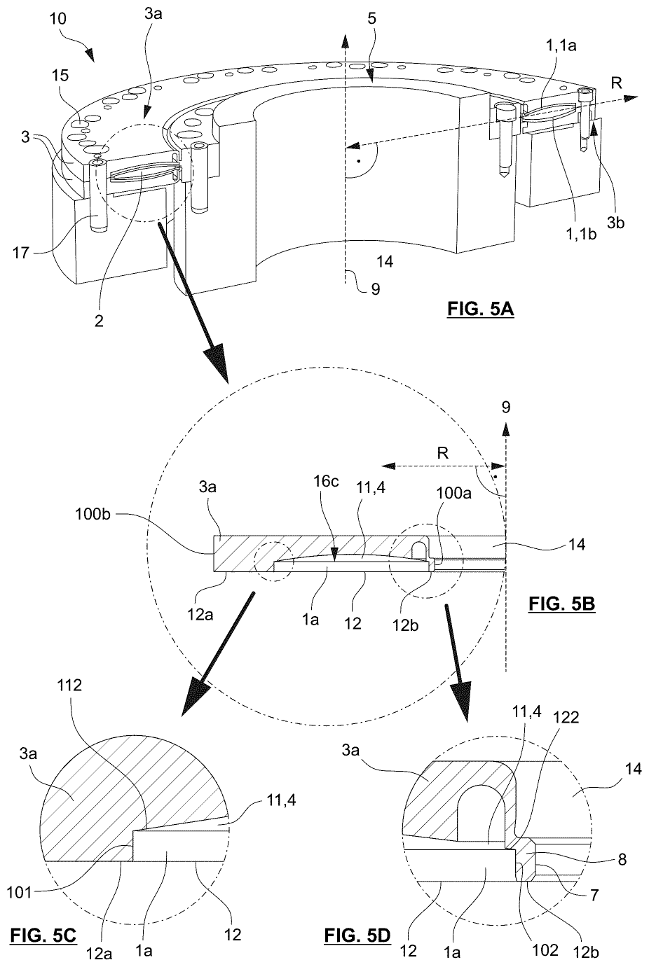

The clamping device 10 according to the invention here comprises a housing 3 comprising a first housing part 3a according to the invention and a second housing part 3b according to the invention. The housing parts 3a, 3b according to the invention here comprise the means mentioned at the outset, specifically a second edge 100a of the housing part 3a, 3b and a first edge 100b of the housing part 3a, 3b, wherein the edges 100a, 100b are situated opposite one another; an annular cutout 11, which is arranged between the second edge 100a and the first edge 100 b, for clamping an annular spring plate 1a, 1b between a first bearing face 101, which is defined by the cutout 11, of the housing part 3a, 3b and a second bearing face 102, which is defined by the cutout 11, of the housing part 3a, 3b; a clamping element 8 having a clamping face 7 which is designed, when the spring plate 1a, 1b is clamped in the cutout 11 between the first bearing face 101 and the second bearing face 102 in such a way that a first end of the spring plate 1a, 1b is supported on the first bearing face 101 and a second end of the spring plate 1a, 1b presses onto the second bearing face 102, to transmit a clamping and/or braking force to an object 5 which is to be clamped and/or braked; a first housing contact face 12a which extends between the first edge 100b and the first bearing face 101; wherein at least one groove 110 for receiving a sealing means is arranged or inserted on the first housing contact face 12a. These means will be explained in more detail in conjunction with FIGS. 5, 6 and 8.

The two housing parts 3a, 3b of the clamping device 10 according to the invention which is represented in FIGS. 1A to 5A are arranged with respect to one another and fastened to one another in such a way that the first housing contact face 12a of the first housing part 3a faces the first housing contact face 12a of the second housing part 3b, and that the recesses 11 of the first and second housing parts 3a, 3b together form an interior space 13 within the housing 3. The clamping device 10 further comprises a spring 1 which is arranged in the interior space 13 and comprises a first annular spring plate 1a and a second annular spring plate 1b, wherein the spring plates 1a, 1b are arranged within the interior space 13 in such a way that at least one pressure space 2, 4 is formed in the interior space 13, which pressure space is at least partially delimited by the spring plates 1a, 1b, wherein the pressure space 2, 4 can be aerated or deaerated and can be subjected to overpressure of a pressure medium which is suppliable to the housing 3, wherein the first spring plate 1a is clamped between the first contact face 101 of the first housing part 3a and the second contact face 102 of the first housing part 3a; wherein the second spring plate 1b is clamped between the first contact face 101 of the second housing part 3b and the second contact face 102 of the second housing part 3b; and wherein the spring plates 1a, 1b are arranged relative to the at least one pressure space 2, 4 in such a way that a bending of at least one of the spring plates 1a, 1b is changeable by aerating or deaerating the pressure space 2, 4 or subjecting the pressure space 2, 4 to overpressure, and as a result the device 10 changes between an open state, in which the object 5 is spaced apart from the clamping surfaces 7, and a closed state, in which one or more of the clamping surfaces 7 transmit a clamping and/or braking force to the object 5.

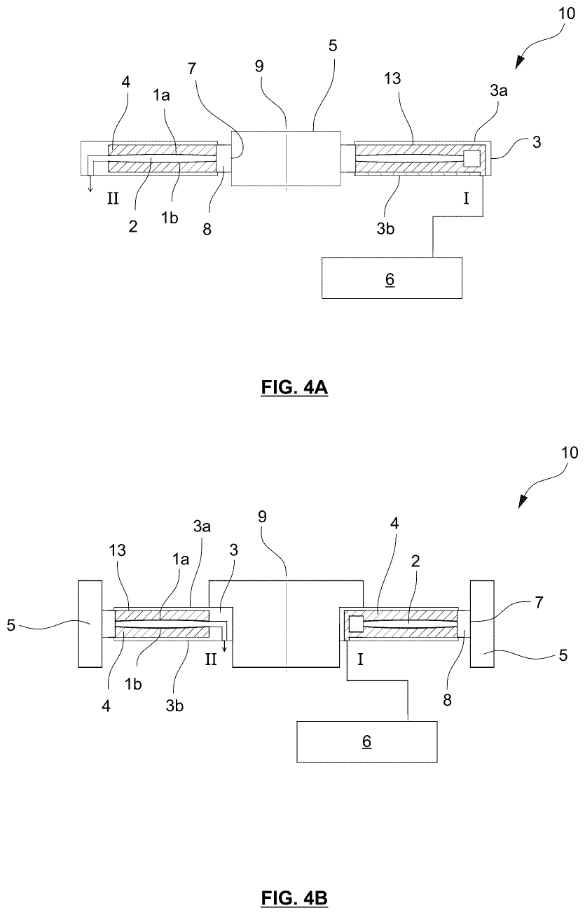

FIGS. 1A, 1B, 4A and 4B each show such clamping devices 10 in the closed state in that the clamping surface 7 of the clamping element 8 touches the circumference of the object 5. The clamping element 8 is also referred to as a clamping lip. The clamping element 8 can be formed in one piece with the remaining parts of the housing part 3a, 3b or can be a component of the housing part 3a, 3b which is structurally separated from the remaining parts.

The clamping force or action of the clamping surface 7 on the object 5 to be clamped takes place in a clamping plane which is spanned by two vectors which each form a radius of the annular elastic elements 1a, 1b or annular recess 11 (cf. FIG. 5A). The axis 9 can run through the center point of the ring of the components described here as annular and can therefore be referred to as the main axis of the clamping device 10 which can run perpendicularly to the clamping plane. If “inner/inner” and “outer/outer” housing contact surface, bearing surface, edge or end are referred to in this document, then inner housing contact surface, bearing surface, edge or end can be closer to the axis 9 than correspondingly outer housing contact surface, bearing surface, edge or end. The same can also apply to other components. Other meanings of the terms “inner/inner(r)” and “outer/outer(r)” are possible.

The clamping device 10 can be of rotationally symmetrical configuration about this main axis 9. The main axis 9 can run approximately or precisely centrally through an opening of the clamping device 10 (opening 14 in FIG. 5B). In FIGS. 1A, 4A, the object 5 to be clamped, for example a rotatable shaft of a machine or of a table, is placed within the opening 14 and the clamping force of the clamping device is therefore directed radially inward towards the main axis 9 (perpendicularly to the main axis 9) within the clamping plane. In FIGS. 1B, 2B, 3B, 4B, the object 5 to be clamped is placed outside the clamping device 10 and the clamping force of the clamping device is therefore directed radially outward away from the main axis 9 (perpendicularly to the main axis 9) within the clamping plane.

In FIGS. 1A, 2A, 3A, 4A, the clamping element 8 is located between spring 1 and opening 14 or main axis 9. By contrast, in FIGS. 1B, 2B, 3B, 4B, the object 5 to be clamped at least partially surrounds the clamping device 10, with the result that the clamping element 8 is located there between object 5 and opening 14 or main axis 9. In FIGS. 1B, 2B, 3B, 4B, a component which at least partially fills the opening 14 and through which the main axis 9 extends can be introduced into opening 14 instead of the object 5 to be clamped.

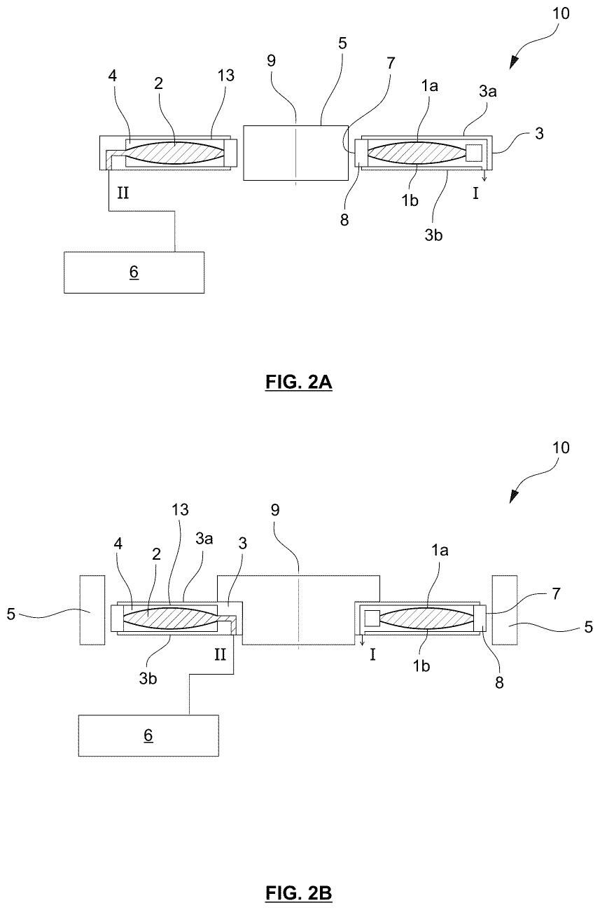

In FIGS. 1A to 5A, in each case the spring 1 is clamped between two bearing surfaces (first bearing surface 101 and second bearing surface 102 in FIGS. 5C and 5D) within the housing 3 of the clamping devices 10 and extends between the two bearing surfaces. In the pressureless initial state of the device 10 in FIGS. 1A to 2B, the spring 1 can be slightly bent in order to be fixed fixedly in the housing 3 in this state, and the same can apply to any other state of the device 10, wherein the degree of bending of the spring 1 depends on the state in which the device 10 is located. If the device 10 is in a state in which the spring 1 is bent (for example bent more than in the pressureless initial state, such as, for example, in the open state), deaerating of a second (for example inner) pressure chamber 2 of the spring 1 and aerating of a first (for example outer) pressure chamber 4 can lead to at least partial relaxation of the spring 1 while the spring 1 presses against the radial bearing surfaces, the distance of which increases somewhat, with the result that the housing 3 is elastically deformed in the region of the clamping element 8 or the clamping surface 7 and the clamping surface 7 thereby touches the object 5 and is pressed against the object 5 with a (predefined) clamping force in order to clamp the object 5 fixedly. The object 5 is clamped fixedly and the clamping device 10 is in the closed state, as shown in FIGS. 1A and 1B. In the closed state of the device 10, the spring 1 can still be slightly bent even after the partial relaxation in order to be fixed fixedly in the housing 3 in this state.

In this case, the clamping element 8 can be an elastic element, such as, for example, a spring fork, which, in the pressureless initial state of the device 10, is moved by the spring force of the (slightly) bent spring 1 from an initial position, in which the elastic element is relaxed, into a braced position, for example by bending of the spring fork 8, until an equilibrium arises between a restoring force of the elastic element 8 and the spring force of the spring 1 in the pressureless initial state. In this equilibrium, the clamping surface 7 can press against the object 5.

By additional application of compressed air (for example with 4 bar or 6 bar) to the first pressure chamber 4 in the closed state, there is the optional possibility of increasing the clamping force by a predetermined value. This is indicated in FIGS. 1A, 1B by the optional additional compressed air pump (booster) 6 and the hatching (compressed air) in the first pressure chamber 4. The pressure chamber 4 (“outer pressure chamber 4”) arranged on the outer side (upper side or underside) of the spring plates can be connected by means of an opening in the housing 3 to an air port I (also referred to as “close”), to which the compressed air pump 6 can be connected.

As a result, for example, actuation of the device 10 is possible in such a way that a change takes place between a braked movement (in the pressureless state) of the subjected object 5 and complete clamping of the object (in the case of sufficient application of pressure).

Even if two pressure chambers 2, 4 are shown and described here by way of example, the clamping device 10 can also be operated with a single pressure chamber which can be, for example, the pressure chamber 2 (“inner pressure chamber 2”) arranged between the spring plates (on the inner side of the spring plates) or the outer pressure chamber 4.

FIGS. 2A and 2B show the clamping devices 10 from FIGS. 1A and 1B in each case in the open state in which the clamping surface 7 does not touch the circumference of the object 5 or is spaced apart from the circumference of the object 5. The inner pressure chamber 2 can be connected by means of an opening in the housing 3 to an air port II (also referred to as “open”), to which a compressed air pump 6 can be connected.

By application of compressed air (for example 4 bar or 6 bar) to the second (for example inner) pressure chamber 2 by the compressed air pump 6 and deaerating of the first (for example outer) pressure chamber 4, the spring 1, compared with the closed state from FIGS. 1A, 1B, is more strongly (convexly) bent or braced and there is a radial shortening of the spring 1 or of the distance between the two bearing surfaces. The clamping surface 7 lifts off from the object 5 in order to release the clamping. The object 5 is freely movable (for example rotatable about axis 9 or movable linearly along axis 9) and the clamping device 10 is open.

It is possible to change back and forth between the closed state and the open state of the device 10.

Such pneumatic clamps 10 have a number of advantages over hydraulic clamps.

By using the combination of elastic component, in this case a spring 1 together with elastic elements 1a, 1b, and compressed air, for example very short reaction times are achieved when switching between the open and closed state and a secure clamping of the object 5 is likewise brought about. The spring 1 can preferably be of plate-shaped configuration, as shown in more detail in FIG. 5, wherein two elastic elements 1a, 1b lying one on top of the other form the spring 1 and the inner pressure chamber 2 of the spring 1 between the plates 1a, 1b. The plates 1a, 1b can likewise be annular, as shown in FIG. 5, and can optionally additionally have radial slots, so that a change in the inner diameter is possible with particularly low forces. The elastic elements 1a, 1b can be coated with rubber, at least in the region of slots, in order to produce the seal required for the compressed air. The elastic elements 1a, 1b are generally of such pressure-resistant and thus elastically bendable form and are arranged in the housing 3 of the clamping device 10 in such a way that the inner pressure chamber 2 is formed between the elastic elements 1a, 1b within the spring 1 and the outer pressure chamber 4 is formed between each elastic element 1a, 1b and the housing 3 or the housing parts 3a, 3b of the clamping device 10. FIG. 5 shows a three-dimensional view of a clamping device 10 similar to FIGS. 1A and 2A By aerating or application of compressed air to the first (for example outer) pressure chamber 4 and dearating of the second (for example inner) pressure chamber 2, as shown in FIG. 1A, the spring 1 is at least partially relaxed and brings about a clamping force on the object 5 to be clamped, in particular on the circumference of a shaft 5. As a result, in the event of an energy or pressure failure, the object 5 is clamped or the shaft 5 is immediately brought to a standstill and therefore offers a safety clamping. Such pneumatic clamps 10 can, depending on the magnitude, achieve holding torques of several 100 Nm and up to several 1000 Nm, which can be further increased by additional application of compressed air to the first (for example outer) pressure chamber 4, as indicated in FIG. 1A by a pressure pump 6 (booster). Here, a compressed air of a few bar (for example 4 bar or 6 bar) is sufficient for providing a multiple of the holding torques which are achieved without a booster. In this case, use is made of the fact that small transverse bends of the plates 1a, 1b (perpendicularly to the longitudinal axis thereof) generate large spring forces when switching between the open and closed state of the clamp 10, which spring forces can be used for clamping or for releasing prestressed clamping devices 10. This enables secure clamping and release even of rapidly rotating machine shafts 5.

In the case of pneumatic material, the costs and the assembly outlay are also lower in comparison with the hydraulic material and the use of compressed air results in no additional outlay whatsoever for producing cleanliness on the installation. Such pneumatic clamps also enable a small overall size, since a small transverse bend and a small (change in the) longitudinal extent of the spring, and therefore small volumes of the pressure spaces, are sufficient to apply the required clamping forces.

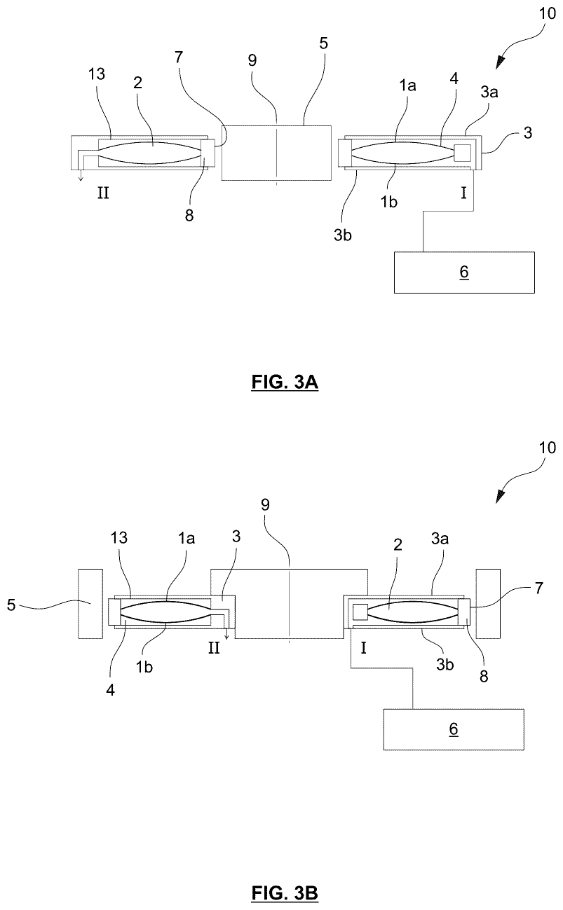

In the case of pneumatic clamps, a distinction is made in principle between passive clamping devices 10, as shown in FIGS. 1A to 2B, and active clamping devices 10, as shown in FIGS. 3A to 4B.

In the pressureless initial state, the spring 1 can be bent to different extents (transversely) and therefore be shortened radially to different extents. The inner side of the housing 3 can be adapted to the bend of the elastic elements 1a, 1b or can define said bend. A corresponding stop surface for the elastic elements 1a, 1b can be formed, for example, by a housing inner wall. The housing inner wall can be of complementary (for example concave) form to a (for example convex) bend of the elastic elements 1a, 1b.

In the case of passive clamping devices 10, in the pressureless initial state, the spring 1 is generally bent slightly elastically (for example convexly) or is prestressed, and the clamping devices 10 can be closed (FIGS. 1A, 1B). The clamping device 10 is opened only by application of force from the inside via application of compressed air to the second (for example inner) pressure chamber 2 (FIGS. 2A, 2B). In most cases, the spring 1 is bent somewhat in the pressureless initial state, with the result that, in the case of clamping or in the case of a pressure drop, the spring force which is given by the energy stored in the spring 1 is transmitted to the object 5 to be clamped as a clamping force in order to clamp the object 5.

In the case of active clamping devices 10, in the pressureless initial state (FIGS. 3A, 3B), the spring 1 is curved transversely outwards more strongly, in particular more strongly convexly, than in the case of passive clamping devices, with the result that the distance between the two radial bearing surfaces is shortened and the clamping device 10 is opened. No clamping force is brought about via clamping surface 7 on the object 5. The object is free since the clamping surface 7 does not touch the object 5 or is spaced apart from the object 5.

By plastic deformation of the spring plates 1a, 1b, in the case of the same housing 3, the spring 1 can be curved transversely outwards more strongly in the pressureless initial state and therefore be shortened radially more strongly than in the case of passive clamping devices. This smaller radial extent of the spring plates 1a, 1b in the pressureless initial state can lead to an open state of the clamping device 10 in the pressureless initial state. Even in the case of plastic deformation, the spring plates 1a, 1b are elastically bent and press against the bearing surfaces so that the spring is fixed in the housing. The interior space of the housing or the recesses can accommodate the curvature brought about more strongly by plastic deformation in the initial state.

The clamping force now has to be induced actively from the outside, as shown in FIGS. 4A and 4B, in order to transfer the clamp into the closed state. Here, compressed air is introduced into the first (for example outer) pressure chamber 4 by a compressed air pump 6 and therefore compressed air is applied to the spring 1 from the outside in such a way that the spring 1 is actively relaxed, the curvature of the spring 1 is reduced, the distance between the two bearing surfaces is increased, and the housing 3 elastically deforms in the region of the clamping element 8 or the clamping surface 7, so that the clamping surface 7 touches the object 5 and brings about a clamping force on the object 5 and the object 5 is thereby clamped fixedly. The active clamping device 10 is then in the closed state.

Depending on the field of application and prescribed safety regulations, an active or passive clamping system 10 is therefore used. If a safety clamping is primarily desired, a passive clamping device is generally used. With such pneumatic passive clamping systems, it is possible, even in the pressureless state, during corresponding assembly of the device in an overall device, to generate a predetermined clamping force with which the object 5 to be clamped is acted upon. As a result of the application of overpressure or negative pressure, the forces transmitted to this object can be increased, reduced or completely cancelled, which opens up diverse applications. If, by contrast, a deliberate operation, such as a tool change, is to be carried out primarily with the clamping device, an active clamping device is generally used.

FIG. 5A shows a cross section through a pneumatic clamping device 10 according to the invention in a three-dimensional representation, the device 10 with inwardly directed clamping force according to FIGS. 1A, 2A, 3A and 4A being shown here by way of example. FIGS. 5B to 8 then show further details of this device 10. However, what is shown for the device in FIGS. 5A to 8 correspondingly applies to the device 10 with outwardly directed clamping force according to FIGS. 1B, 2B, 3B and 4B.

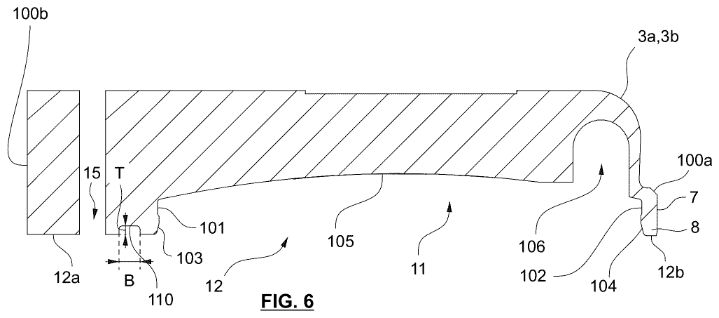

As represented in FIG. 5A, the housing 3 of the clamping devices 10 according to the invention comprises two housing parts 3a, 3b according to the invention, in each case with a groove (not shown here) (cf. 110 in FIG. 6), wherein the housing parts 3a, 3b are fastened to one another by fastening means 17, such as for instance screws, through holes 15 and are mounted in such a way that, in the mounted state, the grooves of the housing parts coincide with one another and the two housing parts a, 3b define the interior space 13 between the housing parts 3a, 3b within the housing 3, in which interior space the spring 1 together with the annular spring plates 1a, 1b thereof are arranged. The housing parts 3a, 3b each define a recess 11 which is likewise annular and which serve for receiving the annular spring plates 1a, 1b, as represented in FIGS. 5A to 5D. At least a part of the first bearing surface 101 of the housing part can run (substantially) perpendicularly to the radial direction R of the annular recess 11 and/or a part of the second bearing surface 102 of the housing part can run (substantially perpendicularly) to the radial direction R of the annular recess 11.

An opening 14 (FIG. 5B), into which the object 5 to be clamped, such as for instance a shaft, can be introduced, extends through the center of the housing 3. The housing can extend up to 360° around this opening and at least partially encloses the object 5 in at least one plane which is referred to as the clamping plane. The central main axis 9 of the clamping devices runs centrally through the opening 14 and perpendicularly to the clamping plane. In clamping devices according to FIGS. 1A, 2A, 3A, 4A, 5A, the main axis 9 runs centrally through the shaft along the longitudinal axis thereof.

Located along the circumference of the housing 3 or the opening 14 is one or more of the clamping surfaces 7 which, in the case of an elastic deformation of the housing 3 in the region of the clamping element 8 or the clamping surface 7, brings about the clamping force on the outer circumference of the object 5 and can thereby clamp the object 5. For an effective opening and closing of the clamping device 10 in relation to the object 5 to be clamped, without the risk of damage to the object 5, a symmetrical distribution of the clamping force along the clamping surface 7 or along the circumference of the object 5 is desirable. A non-symmetrical distribution of the clamping force can lead to damage to the object 5. Preferably, one or both abutment surfaces 101, 102 are of circular configuration within the clamping plane. Preferably, the clamping surface 7 is of circular configuration within the clamping plane. The clamping element 8 can be of annular configuration. All annular or circular components described here can each have, individually or in combination, as the center point, the point of intersection of the main axis 9 with the clamping plane (e.g. center point of the opening 14).

FIGS. 5B-D show an embodiment of the housing part according to the invention (here the upper housing part 3a from FIG. 5A). The housing part 3a, 3b according to the invention comprises the means mentioned at the outset, namely a second edge 100a (here the inner edge) of the housing part 3a, 3b and a first edge 100b (here the outer edge) of the housing part 3a, 3b, wherein the edges are arranged opposite one another; an annular recess 11 arranged between the second edge 100a and the first edge 100b for clamping an annular spring plate 1a, 1b between a first bearing surface 101 (here the outer bearing surface) of the housing part 3a, 3b defined by the recess 11 and a second bearing surface 102 (here the inner bearing surface) of the housing part 3a, 3b defined by the recess 11; a clamping element 8 having a clamping surface 7 which is designed, when the spring plate 1a, 1b is clamped in the recess 11 between the first bearing surface 101 and the second bearing surface 102 in such a way that a first end of the spring plate 1a, 1b is supported on the first bearing surface 101 and a second end of the spring plate 1a, 1b presses onto the second bearing surface 102, to transmit a clamping and/or braking force to an object 5 to be clamped and/or braked (cf. FIGS. 5A, 5B, object 5 in the opening 14); a first housing contact surface 12a (here the outer housing contact surface) which extends between the first edge 100b and the first bearing surface 101; wherein at least one groove 110 for receiving a sealing means is arranged or inserted on the first housing contact surface 12a. Preferably, the cross section of the groove 110 formed in the radial direction R by the groove 110 can be in the form of a V (V-shaped, opening of the V in the direction of the surface 12a), a rectangle open on one side towards the surface 12 a, a U (U-shaped, opening of the U in the direction of the surface 12a) or a semicircle. The housing part 3a, 3b can comprise a second housing contact surface 12b (here the inner housing contact surface) which extends between the second bearing surface 102 and the second edge 100b.

The housing part 3a, 3b extends between the second edge 100a, which is located here closer to the axis 9, and the first edge 100b, which is located here further away from the axis 9, and can preferably be of annular configuration. The housing part 3a comprises the annular recess 11 for clamping the annular spring plate 1a, wherein the housing part 3a has an inner surface (cf. 105 in FIG. 6) defined by the recess 11. The annular recess 11 preferably defines an annular opening 12 in the housing part, wherein the annular opening is formed between the first (for example annular) housing contact surface 12a of the housing part and the second (for example annular) housing contact surface 12b of the housing part.

When the spring plate 1a with the first, upper side surface (cf. 16c in FIG. 5B) facing the inner surface 105 is introduced through the opening 12 into the recess 11 and clamped in the recess 11, the first pressure space 4 is formed between the inner surface 105 and the spring plate 1a. As shown in FIGS. 5C and 5D, the illustrated spring plate 1a of the spring 1 extends from a first bearing surface 101 within the housing part 3a to a second bearing surface 102 within the housing part 3a and can touch the latter. The first bearing surface 101 is in this case arranged radially further outward than the second bearing surface 102 as seen from the center point of the opening 14.

FIG. 5C shows the section of the housing part 3a illustrated in FIG. 5B in which the upper plate 1a of the spring 1 meets the first bearing surface 101 and is preferably in contact with the latter. FIG. 5D shows the section of the housing part 3a illustrated in FIG. 5B in which the upper plate 1a of the spring 1 meets the second bearing surface 102 and is preferably in contact with the latter. However, it is also possible for there to be located radially between the spring plate 1a and one or more of the bearing surfaces 101, 102 in each case one or more further components via which the spring plate 1a exerts its spring force on the bearing surfaces 101, 102.

As can be seen in FIGS. 5B-5D, the spring plate 1a is clamped in the recess 11 between bearing surfaces 101, 102 of the housing part 3a. Each of the plates of the spring 1 is introduced in the direction of the main axis 9 of the clamping devices 10 through the opening 12 into the recess 11 of the respectively associated housing part during assembly along the bearing surfaces 101, 102 of the housing part 3a until the respective plate butts against a stop 112, 122 at the end of each of the two bearing surfaces 101, 102 and therefore cannot be introduced further into the recess 11. Since the extent of the spring plate 1a in the clamping plane or in the radial direction of the annular recess can be greater than the extent of the interior space defined by the housing part, the plate 1a can be bent or prestressed in the pressureless initial state.

The spring plate 1a can be coated (for example vulcanized) with an elastic, sealing material, preferably rubber or another suitable material.

FIG. 6 shows more details of the housing part 3a according to the invention from FIG. 5B. FIG. 6 shows, in addition to the recess 11, the first bearing surface 101, and the second bearing surface 102, also the groove 101, and further optional means such as inner surface 105, hole 15, bevels 103, 104 and an indentation 106.

The housing part 3a, 3b comprises an annular recess 11 for clamping the annular spring plate 1a, 1b, wherein the recess 11 can form a first annular edge on the first housing contact surface 12a and a second annular edge on the second housing contact surface 12b of an annular opening 12 of the housing part 3a, 3b, wherein the annular recess 11 defines the inner surface 105 of the housing part 3a, 3b between the first annular edge and the second annular edge, wherein the inner surface 105 forms a first bevel 103 (or long chamfer) in the region of the first annular edge and the inner surface 105 forms a second bevel 104 (or long chamfer) in the region of the second annular edge, wherein the bevels 103, 104 are oriented such that the annular opening 12 enlarges towards the first and second annular edges or the corresponding housing contact surfaces (cf. 12a, 12b in FIG. 6).

When the spring plate 1a, 1b with the first side surface 16c facing the inner surface 105 is clamped in the recess 11, the coating of the spring plate 1a, 1b will produce a preferably sealing contact with at least one first section of the inner side of the housing part 3a, 3b. The first section can comprise the bearing surfaces 101, 102, the bevels 103, 104 and/or other parts of the inner surface 105. The indentation 106 is conducive to the dynamics of the clamping element 8, which can further bend as a result.

The inner surface 105 can comprise the first, first bearing surface 101 and the second bearing surface 102, which are formed to clamp the spring plate 1a, 1b therebetween, wherein the first bevel 103 is arranged between the first bearing surface 101 and the first annular edge of the surface 12a and wherein the second bevel 104 is arranged between the second bearing surface 102 and the second annular edge of the surface 12a. When the spring plate 1a, 1b with the first side surface 16c facing the inner surface 105 is clamped in the recess 11, the coating of the plate 1a, 1b can be brought into preferably sealing contact with the bevels 103, 104.

As shown in FIG. 6, the first bearing surface 101 can form or merge into a first bevel 103 (or long chamfer) and/or the second bearing surface 102 can form or merge into a second bevel 104 (or long chamfer), wherein the bevels 103, 104 are each preferably oriented such that the annular opening 12 or the recess 11 enlarges towards the first and second edges of the surfaces 12a, 12b (cf. FIGS. 6 and 5B).

The housing part 3a, 3b has a, preferably circular, groove or groove 110 for receiving a sealing means (for example sealing compound or rubber O-ring) on the first housing contact surface 12a. The groove or groove 110 can run partially or preferably completely around the housing part 3a, 3b along (for example parallel to) the first edge 100b of the housing part on the first housing contact surface 12a, between the first edge 100b of the housing part and the first bearing surface 101 or the recess 11. The groove or groove 110 can run partially or preferably completely around the housing part 3a, 3b alternatively or additionally along the circumference of the housing part in the region of the surface 12b, or between a second edge 100a of the housing part and the second bearing surface 102 or the recess 11.

As represented by way of example in FIG. 6, the first housing contact surface 12a can furthermore have one or more holes 15 for fastening the housing part 3a to another housing part 3b by means of a fastening means 17 (cf. FIG. 5B). The groove 110 can extend on the first housing contact surface 12a between the holes 15 and the first bearing surface 101. The holes 15 are arranged on the first housing contact surface 12a between the first edge 100b and the groove 110. The groove 110 can have a width B of 1 mm to 2 mm, 1.4 mm to 1.6 mm, or 1.5 mm. The groove can have a depth of 0.5 mm to 1.0 mm, 0.65 mm to 0.75 mm, or 0.7 mm. These dimensions are particularly advantageous in order to receive and specifically attach precisely as much sealing means as required (e.g. O-ring, adhesive and sealing materials, etc.). The consumption of sealing means is thereby reduced.

One advantage of the groove 110 is the achievement of the sealing function which is important for the operation during operation with CLOSE over many million additional air (booster) switching processes, making it possible to apply the sealing means (adhesive and sealing material) between the housing halves in a targeted manner and thereby to reduce the consumption. As a result of the change in the pitch circle diameter for the connecting screws, the groove can be introduced circumferentially between the ports OPEN and CLOSE.

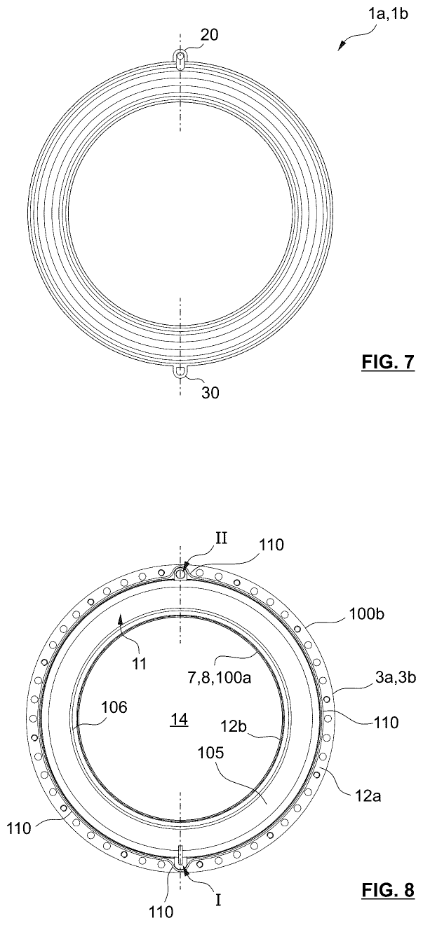

FIG. 7 shows an exemplary embodiment of a spring plate 1a, 1b with a first port seal 30 and/or a second port seal 20. The seals 20, 20 can be made of an elastic, sealing material, such as rubber, and can be part of an elastic, sealing coating (for example rubber coating) of the spring plate, which is vulcanized, for example, onto the spring plate.

The first port seal 30 and the second port seal 20 can be arranged on opposite sections of the second edge 100a or first edge 100b of the annular spring plate.

The first port seal 30 can be arranged at least in sections radially inwardly or outwardly offset with respect to the second edge 100a and/or first edge 100b (cf. FIG. 7) of the spring plate 1a, 1b. The first port seal 30 can project in the radial direction beyond the second edge 100a or the first edge 100b (cf. FIG. 7).

The second port seal 20 can be arranged at least in sections radially inwardly or outwardly offset with respect to the second edge 100a and/or first edge 100b (cf. FIG. 7) of the spring plate 1a, 1b. The second port seal 20 can project in the radial direction beyond the second edge 100a or the first edge 100b (cf. FIG. 7).

The spring plate 1a, 1b according to FIG. 7 can be clamped in the housing part 3a, 3b according to FIGS. 5B, 6 and 8. In this case, the elastic element 1a, 1b is clamped in the recess 11 between the second edge 100a (or clamping element 8 with clamping surface 7 or second housing contact surface 12b) and the first edge 100b (or first housing contact surface 12a) of the housing part 3a, 3b in such a way that the first port seal 30 comes into contact with the region of the first port I of the housing part 3a, 3b for applying a pressure medium to the housing part and the second port seal 20 comes into contact with the region of the second port II of the housing part 3a, 3b for applying a pressure medium to the housing part (cf. FIGS. 7, 8). This is carried out twice, with the result that two such housing parts 3a, 3b with spring plate 1a, 1b clamped in in each case are prepared, which are then fastened to one another in order to form a housing 3 as shown in FIG. 5A.

The groove 110 runs on the first housing contact surface 12a and can be designed to run at least partially around the object 5 (cf. FIG. 5A). The groove 110 can extend at least partially along an arc of a circle. The arc of a circle can span a centre angle of at least 45°, 90°, 120°, 135°, 160°, 180°, 225°, 270°, 315°, 350°, or 360°. In FIG. 8, the centre angle is 360°, because the groove 110 once runs completely around the center point of the opening 14.

However, the groove 110 can be interrupted by one or more of the ports I, II and/or, as shown in FIG. 8, the groove 110 on the first housing contact surface 12b can run between the first edge 100b of the housing part 3a, 3b and one or more of the ports I, II and preferably run at least partially around the ports. These optional possibilities each and in combination additionally increase the seal since the groove 110 is guided as far as the ports I, II and possibly even runs partially around the ports in such a way that the sealing means located in the groove 110 seals the ports I, II with respect to the first edge 100b of the housing part and therefore with respect to the surroundings. This reduces the susceptibility to fault by reducing leakage in the region of the ports I, II.

In FIGS. 5 to 8, a sealing means (for example a rubber ring, O-ring made of rubber) can be received in the groove (cf. 110) of each housing part 3a, 3b. In this case, a respective separate sealing means (that is to say a total of at least two sealing means per housing 3 of the clamping and/or braking device 10) can be present in each of the housing parts 3a, 3b or a single sealing means can be received in the grooves of the housing parts 3a, 3b when the housing parts 3a, 3b are fastened to one another.

As already explained, FIGS. 5 to 8 show by way of example components of the device 10 with inwardly directed clamping force according to FIGS. 1A, 2A, 3A and 4A. In this case, the first edge 100b is the outer edge along which the optional holes 15 are arranged and the second edge 100a is the inner edge which faces the object 5. The second bearing surface 102 is then located further inward in comparison with the first bearing surface 101.

However, what is shown for the device in FIGS. 5A to 8 correspondingly applies to the device 10 with outwardly directed clamping force according to FIGS. 1B, 2B, 3B and 4B. In the latter case, the first edge 100b would be the inner edge along which the optional holes 15 are arranged and the second edge 100a would be the outer edge which faces the object 5. The second bearing surface 101 is then located further outward in comparison with the first bearing surface 101.

By means of the means described here individually and in combination, it is possible to provide clamps which seal reliably between the housing parts and with respect to the surroundings without the dynamics of the opening and closing of the clamp being adversely affected as a result.

Preferred embodiments of the subject matter claimed by the appended claims are described in the description and in the figures. The optional features disclosed in the above description, the claims and the drawings can be used both individually and in any desired combination for the realization of the subject matter claimed here according to the appended claims in its various configurations.

The various aspects and embodiments described above can be combined to create yet further embodiments. These and other changes can be made to the embodiments in the light of the above detailed description. In general, the terms used in the following claims should not be construed as limiting the claims to the specific aspects and embodiments disclosed in the description and the claims, but as encompassing all possible embodiments together with the full scope of equivalents to which such claims are entitled.

1-25. (canceled)

26. A housing part for a pneumatic clamping and/or braking device, the housing part comprising:
a first edge of the housing part and a second edge of the housing part opposite the first edge;
an annular recess arranged between the second edge and the first edge for clamping an annular spring plate between a first bearing surface of the housing part defined by the recess and a second bearing surface of the housing part defined by the recess;
a clamping element having a clamping surface which is designed, when the spring plate is clamped in the recess between the first bearing surface and the second bearing surface in such a way that a first end of the spring plate is supported on the first bearing surface and a second end of the spring plate presses onto the second bearing surface, to transmit a clamping and/or braking force to an object to be clamped and/or braked; and
a first housing contact surface which extends between the first edge and the first bearing surface;
wherein at least one groove for receiving a sealing means is arranged on the first housing contact surface;
wherein the housing part has one, two or more ports for applying a pressure medium to the housing part;
wherein the at least one groove is interrupted by one or more of the ports; and/or
wherein the at least one groove on the first housing contact surface runs between the first edge of the housing part and one or more of the ports.

27. The housing part according to claim 26, wherein the first housing contact surface furthermore has one or more holes for fastening the housing part to another housing part by means of a fastening means.

28. The housing part according to claim 27, wherein the at least one groove on the first housing contact surface extends between the holes and the first bearing surface.

29. The housing part according to claim 27, wherein the holes on the first housing contact surface are arranged between the first edge and the at least one groove.

30. The housing part according to claim 26, wherein the groove extends at least partially along an arc of a circle and/or the at least one groove is designed to run at least partially around a centre point of the annular recess.

31. The housing part according to claim 26, wherein the at least one groove, which runs on the first housing contact surface between the first edge of the housing part and one or more of the ports, runs at least partially around the ports.

32. The housing part according to claim 26, wherein the housing part is designed in such a way that, when the second end of the spring plate presses onto the second bearing surface, the housing part elastically deforms in the region of the clamping element and/or the second bearing surface and thereby the clamping surface transmits the clamping and/or braking force to the object to be clamped and/or braked.

33. The housing part according to claim 26, wherein the housing part furthermore comprises: a second housing contact surface which extends between the second bearing surface and the second edge of the housing part.

34. The housing part according to claim 33, wherein the annular recess defines an annular opening for inserting the spring plate into the housing part, wherein the annular opening is formed between the first housing contact surface and the second housing contact surface.

35. The housing part according to claim 26, wherein the second bearing surface and the clamping surface are arranged on mutually opposite side surfaces of the clamping element, preferably with a second housing contact surface arranged therebetween, and/or the clamping surface is arranged at or on the second edge.

36. The housing part according to claim 26, wherein the distance of the second bearing surface from the second edge or the clamping surface is smaller than the distance of the first bearing surface from the second edge or the clamping surface, and/or the distance of the first bearing surface from the first edge is smaller than the distance of the second bearing surface from the first edge and/or the second edge of the housing part is closer to the object than the first edge in the state installed in the clamping and/or braking device and/or the second housing contact surface of the housing part is closer to the object than the first housing contact surface in the state installed in the clamping and/or braking device.

37. A clamping and/or braking device for clamping and/or braking an object to be clamped and/or braked, comprising:
a housing comprising a first housing part according to claim 1 and a second housing part according to claim 1,
wherein the two housing parts are arranged with respect to one another and fastened to one another in such a way that the first housing contact surface of the first housing part faces the first housing contact surface of the second housing part, and that the recesses of the first and second housing parts together form an interior space within the housing; and
wherein a sealing means is received in the respective groove of each of the housing parts; and
a spring which is arranged in the interior space and comprises a first annular spring plate and a second annular spring plate, wherein the spring plates are arranged within the interior space in such a way that at least one pressure space is formed in the interior space, which pressure space is at least partially delimited by the spring plates, wherein the pressure space can be aerated or deaerated and can be subjected to overpressure of a pressure medium which is suppliable to the housing;
wherein the first spring plate is clamped between the first bearing surface of the first housing part and the second bearing surface of the first housing part;
wherein the second spring plate is clamped between the first bearing surface of the second housing part and the second bearing surface of the second housing part; and
wherein the spring plates are arranged relative to the at least one pressure space in such a way that a bending of at least one of the spring plates is changeable by aerating or deaerating the pressure space or subjecting the pressure space to overpressure, and as a result the device changes between an open state, in which the object is spaced apart from the clamping surfaces, and a closed state, in which one or more of the clamping surfaces transmit a clamping and/or braking force to the object.

38. A clamping and/or braking device for clamping and/or braking an object to be clamped and/or braked, comprising:
a housing comprising a first housing part and a second housing part, wherein each of the housing parts comprises:
a first edge of the housing part and a second edge of the housing part opposite the first edge;
an annular recess arranged between the second edge and the first edge for clamping an annular spring plate between a first bearing surface of the housing part defined by the recess and a second bearing surface of the housing part defined by the recess;
a clamping element having a clamping surface which is designed, when the spring plate is clamped in the recess between the first bearing surface and the second bearing surface in such a way that a first end of the spring plate is supported on the first bearing surface and a second end of the spring plate presses onto the second bearing surface, to transmit a clamping and/or braking force to an object to be clamped and/or braked; and
a first housing contact surface which extends between the first edge and the first bearing surface;
wherein at least one groove, in which a sealing means is received, is arranged on the first housing contact surface; and
wherein the two housing parts are arranged with respect to one another and fastened to one another in such a way that the first housing contact surface of the first housing part faces the first housing contact surface of the second housing part, and that the recesses of the first and second housing parts together form an interior space within the housing; and
a spring which is arranged in the interior space and comprises a first annular spring plate and a second annular spring plate, wherein the spring plates are arranged within the interior space in such a way that at least one pressure space is formed in the interior space, which pressure space is at least partially delimited by the spring plates, wherein the pressure space can be aerated or deaerated and can be subjected to overpressure of a pressure medium which is suppliable to the housing;
wherein the first spring plate is clamped between the first bearing surface of the first housing part and the second bearing surface of the first housing part;
wherein the second spring plate is clamped between the first bearing surface of the second housing part and the second bearing surface of the second housing part; and
wherein the spring plates are arranged relative to the at least one pressure space in such a way that a bending of at least one of the spring plates is changeable by aerating or deaerating the pressure space or subjecting the pressure space to overpressure, and as a result the device changes between an open state, in which the object is spaced apart from the clamping surfaces, and a closed state, in which one or more of the clamping surfaces transmit a clamping and/or braking force to the object.

39. The clamping and/or braking device according to claim 38, wherein the two housing parts are fastened to one another by means of one or more fastening means which are arranged in the holes.

40. The clamping and/or braking device according to claim 38, wherein the second housing contact surface of the first housing part faces the second housing contact surface of the second housing part.

41. The clamping and/or braking device according to claim 38, wherein the at least one pressure space comprises a first pressure space which is arranged outside the spring between at least one of the spring plates and the housing.

42. The clamping and/or braking device according to claim 41, wherein the first spring plate is designed to reduce its bending by aerating the first pressure space or by subjecting the first pressure space to overpressure in order, when the first end of the first spring plate is supported on the first bearing surface of the first housing part, to press with the second end of the first spring plate onto the second bearing surface of the first housing part in such a way that as a result a transmission of a clamping and/or braking force from the clamping surface of the clamping element of the first housing part to the object to be clamped and/or braked is brought about and the device changes from the open state to the closed state.

43. The clamping and/or braking device according to claim 41, wherein the second spring plate is designed to reduce its bending by aerating the first pressure space or by subjecting the first pressure space to overpressure in order, when the first end of the second spring plate is supported on the first bearing surface of the second housing part, to press with the second end of the second spring plate onto the second bearing surface of the second housing part in such a way that as a result a transmission of a clamping and/or braking force from the clamping surface of the clamping element of the second housing part to the object to be clamped and/or braked is brought about and the device changes from the open state to the closed state.

44. The clamping and/or braking device according to claim 41, wherein the device is designed in such a way that, by aerating the first pressure space or by subjecting the first pressure space to overpressure, the first bearing surface and the second bearing surface of at least one of the two housing parts move away from one another and/or the bending of at least one of the spring plates decreases, and as a result the device changes from the open state to the closed state.

45. The clamping and/or braking device according to claim 38, wherein the at least one pressure space comprises a second pressure space, wherein the second pressure space is arranged within the spring between the two spring plates, preferably wherein the device is designed in such a way that, by aerating the second pressure space or by subjecting the second pressure space to overpressure, the first bearing surface and the second bearing surface of at least one of the two housing parts move towards one another and/or the bending of at least one of the spring plates increases, and as a result the device changes from the closed state to the open state.
